(19) United States
(12) Patent Application Publication
(10) Pub. No.: US 2024/0305030 A1
(43) Pub. Date: Sep. 12, 2024

(54) TYPE-2 CONNECTOR WITH LOW BUILDING HEIGHT

(71) Applicant: Zaptec IP AS, Stavanger (NO)

(72) Inventors: Knut Braut, Sandnes (NO); Fredrik Østrem, Sandnes (NO)

(73) Assignee: Zaptec IP AS, Stavanger (NO)

(21) Appl. No.: 18/263,983

(22) PCT Filed: Feb. 4, 2022
(86) PCT No.: PCT/EP2022/052758

§ 371 Date: Aug. 2, 2023

(30) Foreign Application Priority Data
Feb. 5, 2021 (NO) 20210152

(51) Int. Cl. H01R 13/405; B60L 53/16; H01R 12/58; H01R 13/52

(52) U.S. Cl. CPC H01R 13/405; H01R 12/585; H01R 13/5202; B60L 53/16; H01R 2201/26

(57) ABSTRACT

A Type-2 connector, which is for a charging station, includes power pins and signal pins for transferring power and signals when connected to circuitry of the charging station. Receptacles for receiving and holding the power pins and signal pins are mounted to an upper side of a flat base plate fitted with holes for letting connecting terminals of respective power pins and signal pins be guided to an underside of the base plate for connection to the circuitry of the charging station.

### TECHNICAL FIELD

The invention relates to a connector adapted for a charging system for charging an electric vehicle, and more specifically to details of the connector making in compact and having low energy loss.

### BACKGROUND

Electrical vehicles have become increasingly popular and as such, there are a range of different charging solutions available on the market. Charging solutions range from public fast charging stations to charging stations for home use.

Charging stations intended for home use are normally provided with a standardized Type-2 connector. The connector comprises seven contact points as shown in FIG. 2. These are configured as two small and five larger contact points. The top row consists of two small contacts that are signal pins 110. These are used for signalling between the charging station and a connected electric vehicle. The middle row contains three pins. The centre pin is used for earthing, while the outer two pins are power pins 120 for the power supply, optionally in conjunction with the two pins on the bottom row which are also for power supply.

The female part of the connector will be connected to the charging station, while a corresponding male part will be connected to a charging cable enabling the charging cable to be connected to the charging station.

In today's Type-2 connectors, the contact points conducting power and control signals are normally held in positions by a terminal block and where each contact point is connected to the circuitry of the charging station. In the terminal block, each contact point is pre-placed at respective positions or placed at respective positions after mounting the terminal block to the charging station, e.g. to the PCB of the charging station. This configuration has a form factor determined by the size and design of the terminal block. This configuration will also require a certain length of connected wires from the contact points to the circuitry of the charging station, and thus contribute to some power loss.

The present invention provides an alternative configuration of a Type-2 connector, which is compact and provides minimal low energy loss to connected contact points in the connector.

The solution is adapted to be integrated in a charging system in compliance with the international standard IEC 61851-1. The Type-2 connector according to the invention is further in compliance with the international standard IEC 62196-2 defining designs of vehicle connectors.

### SUMMARY

The invention is defined by a Type-2 connector for a charging station. The connector comprises power pins and signal pins for transferring power and signals when connected to circuitry of the charging station. The power pins and signal pins of the connector are mounted to an upper side of a flat base plate fitted with holes for transferring connecting terminals of respective power pins and signal pins to an underside of the base plate for connection to the circuitry of the charging station.

Further characteristics of the invention are defined in the claims.

### DETAILED DESCRIPTION

The invention will now be described with reference to the figures.

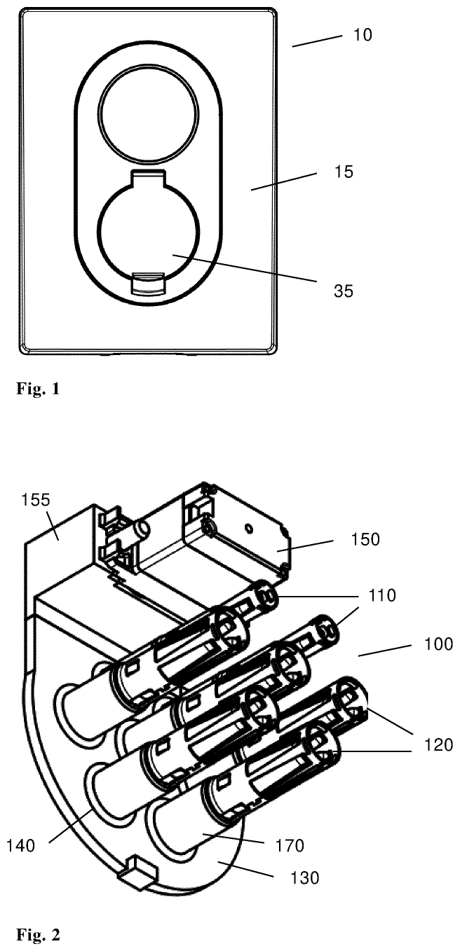

FIG. 1 illustrates a charging station where the invention is implemented.

FIG. 2 is a perspective view of a Type-2 connector according to the invention.

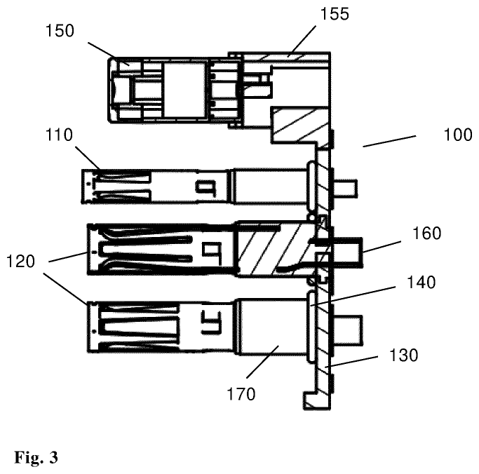

FIG. 3 is a side view of a Type-2 connector according to the invention.

FIG. 1 illustrates an example of a charging station 10 where the invention is implemented. The illustration shows a wall mounted charging station 10.

The charging station 10 has an interface enabling connection to an electric vehicle.

The interface is a Type-2 connector 100 adapted for receiving a plug connected to one end of a charging cable where the other end of the charging cable is connected to a plug adapted to be inserted in a connector of the electric vehicle. In the figure, a lid 35 is shown covering the connector 100 shown in FIG. 2.

FIG. 2 a perspective view of a Type-2 connector 100 according to the invention, while FIG. 6 shows a side view.

When assembled it is connected to circuitry of the charging station which in turn is connected to an external power supply.

The charging station typically comprises controller electronics for controlling power flowing through the connector 100.

According to the invention, the type-2 connector comprises power pins 120 and signal pins 110 for transferring power and signals when connected to circuitry of the charging station 10.

The pins are preferably made by a stamping and rolling process. This provides less weight than prefabricated pins used for same purpose. It further means less strain on a connected printed circuit board thereby avoiding breaking off solder or a press-fit connection when connected to the printed circuit board. It is also easier to solder the pins to the printed circuit board. The insertion force that must be applied for connecting a matching plug will be less than with prefabricated pins due to the spring effect achieved by the stamping and rolling process. This will in turn provide a longer lifetime for the connector 100.

The power pins 120 and signal pins 110 of the connector 100 are mounted to an upper side of a flat base plate 130, made of for instance a plastic material of laminate. This is fitted with holes for letting connecting terminals 160 of respective power pins 120 and signal pins 110 be guided to an underside of the base plate 130. The figures show an embodiment where the power pins 120 and signal pins 110 are mounted perpendicular to the flat base plate 130. They may however, in another embodiment, be mounted in an angled position that is less than 90 degrees relative to the base plate 130.

The connecting terminals are adapted for connection to the circuitry of the charging station 10.

In one embodiment, the power pins 120 and the signal pins 110 are mounted directly to the base plate 130. In another embodiment, the power pins 120 and the signal pins 110 are mounted in receptacles 170 that are mounted to the base plate 130. This provided a more robust support for the power pins 120 and the signal pins 110. The receptables 170 can be moulded in one step together with the base plate 130, or they can be moulded as separate parts fitted together. By moulding the power pins 120 and signal pins 110 of the Type-2 connector directly in the receptacles 170, the whole connector 100 is a single compact part.

In one embodiment, O-rings 140 are mounted to the base of the receptacles 170. This provides a seal between the upper side and the underside of the base plate 130. The seal will prevent humidity to enter the internal of the charging station 100.

In one embodiment, the Type-2 connector further comprises a holder 155 mounted to the upper side of the base plate 130. The holder 155 is adapted for holding a motor for locking a charging connector to the Type-2 connector.

When the different parts of the connector 100 have been connected to the base plate 130, the assembly can easily be fitted to a charging station 10. It may for instance be press-fit to a PCB of the charging station or by soldering the connecting terminals 160 of the power pins 120 and signal pins 110 directly to the PCB.

The solution presented above provides a custom type-2 connector that is easy to assembly in a production. It will have low component height and low production cost. It further provides minimal energy loss due to short distance from connected power pins 120 and signal pins 110 to the circuitry of the PCB.

1. A Type-2 connector for a charging station, the connector comprises power pins and signal pins for transferring power and signals when connected to circuitry of the charging station,
wherein receptacles for receiving and holding the power pins and signal pins are mounted to an upper side of a flat base plate fitted with holes for letting connecting terminals of respective power pins and signal pins be guided to an underside of the base plate for connection to the circuitry of the charging station.

2. The Type-2 connector according to claim 1, where the power pins and signal pins are moulded to the base plate.

3. The Type-2 connector according to claim 2, where O-rings are mounted to the base of the receptacles for sealing the holes.

4. The Type-2 connector according to claim 1, further comprising a holder mounted to the upper side of the base plate, the holder is a adapted for holding a motor adapted for locking a charging connector to the Type-2 connector.

5. The Type-2 connector according to claim 1, wherein the base plate with connected power pins and signal pins is adapted to be press-fit to a PCB of the charging station.

6. The Type-2 connector according to claim 1, wherein the power pins and signal pins of the connector are mounted perpendicular to the flat base plate.

7. The Type-2 connector according to claim 1, wherein the power pins and signal pins of the connector are stamped and rolled.
